(19) United States
(12) Patent Application Publication
(10) Pub. No.: US 2006/0121173 A1
(43) Pub. Date: Jun. 8, 2006

(54) Pre-made, ready-to-drink, alcoholic margarita beverage mix

(76) Inventors: Kathryn J. Black, Lansdale, PA (US); Kim A. Wolpert, Allentown, PA (US)

Correspondence Address: Gary M. Cohen, Esq.;Strafford Building Number Three, Suite 300, 125 Strafford Avenue, Wayne, PA, 19087-3318, US

(21) Appl. No.: 11/006,295

(22) Filed: Dec. 7, 2004

(51) Int. Cl. C12H 1/14

(52) U.S. Cl. 426/592

(57) ABSTRACT

A pre-made, alcohol-containing Margarita cocktail mix having improved taste, quality and consistency includes a combination of concentrated limeade, concentrated lemonade, tequila, triple sec and a brandy-based orange flavored liqueur. The limeade and lemonade are preferably derived from frozen concentrates, combined in equal proportions. An additional orange flavored liqueur is also preferably used, in combination with the triple sec and the brandy-based orange flavored liqueur.

### BACKGROUND OF THE INVENTION

The present invention generally pertains to the variety of alcoholic beverage recipes known as the “Margarita” cocktail, and more particularly, to an improved composition for a so-called “with pulp” style Margarita cocktail.

The “traditional” Margarita cocktail is generally comprised of a combination of separate ingredients including tequila, triple sec and lime juice. Traditionally, the separate ingredients are combined, in desired proportions, to suit the tastes of the consumer. As an alternative, Margarita cocktails are often made from a combination of tequila with a pre-made Margarita mix. Such mixes can be pre-made by the individual consumer, but are generally acquired as a commercial product.

A variety of styled Margarita cocktails have also been developed. One such variety includes ingredients for providing the mixed cocktail with a “pulp-like” consistency, which is primarily developed using natural fruit juices. Such pulp-style Margarita cocktails are often used as a substitute for the commercially available pre-made mixes which are used to develop a traditional Margarita cocktail recipe, as well as traditional Margarita cocktail recipes made from separate ingredients.

Available Margarita cocktails employing a pre-made Margarita mix generally incorporate an artificial green coloring. This provides the resulting Margarita cocktail with a lime green color, which is generally considered to be desirable. However, the artificial lime green color which is imparted to the resulting Margarita cocktail is provided without imparting the pulp-like texture or the natural hue which would result from the use of actual fruit juices. Moreover, in practice, it has been found that the taste of Margarita cocktails made from such pre-made mixes is capable of significant improvement.

Yet another consideration is that because of the different ingredients that can be used in a Margarita cocktail, as well as the widely varying proportions that can be used for such ingredients, any given Margarita cocktail is generally characterized by a taste which is significantly different from blends produced by others, or even the same individual at a different time. As a result, it is generally considered difficult to obtain a consistent, and consistently enjoyable Margarita cocktail.

To overcome this drawback, there is significant interest in the development of a consistent formulation for a Margarita cocktail, particularly one which can be acquired as a convenient, ready-made beverage. This also avoids the need to obtain the separate ingredients necessary to make a Margarita cocktail, further enhancing the popularity of such pre-made, alcoholic beverages.

As a result, a wide variety of Margarita mixes have been developed. The majority of these mixes do not include the alcoholic components of the beverage. However, some pre-made, ready-to-drink (i.e., alcohol-containing) Margarita cocktail mixes are available. For example, pre-made mixes containing alcoholic components are available from producers including the “Jose Cuervo”, “Sauza Salvador's” and “Tarantula Azul” brands. In practice, it has been found that such products are lackluster, often mediocre, and that such products do not rise to the level of a quality Margarita cocktail.

### SUMMARY OF THE INVENTION

In accordance with the present invention, it has been found that with suitable variation of the traditional recipe for a Margarita cocktail, to provide texture and natural coloring, as well as the use of quality ingredients, a significantly improved, pre-made Margarita cocktail mix can be provided. The recipe of the present invention also operates to provide a Margarita cocktail mix having improved consistency, with the result that the poured Margarita cocktail is no longer subject to significant variations in taste, quality and consistency. The pre-made, alcoholic Margarita cocktail mix of the present invention has been found to be sufficiently consistent to permit mass marketing of the product through various media (e.g., at liquor stores, bars, restaurants) and in different sizes (e.g., in relatively large bulk quantities, for restaurants, and in individual or multiple serving quantities for the general consumer).

Preferred ingredients for the pre-made, alcoholic Margarita cocktail mix of the present invention include a combination of concentrated limeade, concentrated lemonade, tequila, triple sec and a brandy-based orange flavored liqueur. The limeade and lemonade are preferably derived from frozen concentrates, combined in equal proportions. An additional orange flavored liqueur is also preferably used, in combination with the triple sec and the brandy-based orange flavored liqueur.

Further detail regarding the pre-made, alcoholic Margarita cocktail mix of the present invention may be had with reference to the detailed description which follows.

### DETAILED DESCRIPTION OF THE INVENTION

The pre-made, alcoholic Margarita cocktail mix of the present invention preferably includes a combination of concentrated limeade, concentrated lemonade, tequila, triple sec and a brandy-based orange flavored liqueur.

The limeade and lemonade are preferably derived from frozen concentrates, such as “MinuteMaid” brand frozen concentrates, and are preferably combined in equal proportions. The tequila is preferably a premium brand, such as “Jose Cuervo Especial”. The triple sec is preferably a “Jacquin's” brand. The brandy-based liqueur is preferably Grand Marnier.

The pre-made, alcoholic Margarita cocktail mix of the present invention also preferably includes an additional orange flavored liqueur, in further combination with the triple sec and the brandy-based orange flavored liqueur. The additional orange flavored liqueur is preferably Orangecello.

The pre-made, alcoholic Margarita cocktail mix of the present invention is a ready-to-drink beverage, and can be served with or without ice, or as a frozen slurry, as desired.

The foregoing ingredients are preferably combined in the following proportions to produce the pre-made, alcoholic Margarita cocktail mix of the present invention:

| Ingredient | Proportion |
|---|---|
| limeade concentrate | 20.8% to 24.6% |
| lemonade concentrate | 20.8% to 24.6% |
| tequila | no more than 34% |
| orange flavored liqueur | at least 7.6% |
| triple sec | at least 7.6% |
| brandy-based orange liqueur | no more than 5.2% |

As an example, and for purposes of batch processing, the following ingredients have been used in the proportions specified:

| Ingredient | Proportion |
|---|---|
| frozen limeade concentrate | 11 to 13 ounces |
| frozen lemonade concentrate | 11 to 13 ounces |
| tequila | no more than 18 ounces |
| orange flavored liqueur | at least 4 ounces |
| triple sec | at least 4 ounces |
| brandy-based orange liqueur | no more than 3 ounces |

Also as an example, and for purposes of developing a 52.75 ounce batch quantity of the Margarita cocktail mix of the present invention, the following ingredients, and proportions for such ingredients, have been used:

| Ingredient | Proportion |
|---|---|
| frozen limeade concentrate | 12 ounces |
| frozen lemonade concentrate | 12 ounces |
| tequila | 18 ounces |
| orange flavored liqueur | 4 ounces |
| triple sec | 4 ounces |
| brandy-based orange liqueur | 2.75 ounces |

In practice, the foregoing 52.75 ounce batch will yield approximately nine, 6-ounce, individual Margarita cocktails.

It will be understood that various changes in the details, ingredients and compositions which have been herein described and illustrated in order to explain the nature of this invention may be made by those skilled in the art within the principle and scope of the invention as expressed in the following claims.

What is claimed is:

1. A recipe for a pre-made, alcoholic Margarita cocktail mix, comprising concentrated limeade, concentrated lemonade, tequila, triple sec and a brandy-based orange flavored liqueur.

2. The recipe of claim 1 wherein the limeade and the lemonade are combined in substantially equal proportions.

3. The recipe of claim 1 wherein the limeade and the lemonade are frozen concentrates.

4. The recipe of claim 1 wherein the brandy-based orange flavored liqueur is Grand Marnier.

5. The recipe of claim 1 which further includes an additional orange flavored liqueur, in combination with the triple sec and the brandy-based orange flavored liqueur.

6. The recipe of claim 5 wherein the additional orange flavored liqueur is Orangecello.

7. The recipe of claim 1 wherein the pre-made, alcoholic Margarita cocktail mix is a ready-to-drink mixture.

8. The recipe of claim 1 wherein the pre-made, alcoholic Margarita cocktail mix is a frozen slurry mixture.

9. A recipe for a pre-made, alcoholic Margarita cocktail mix, comprising ingredients combined in proportions substantially including:

| | |
|---|---|
| limeade concentrate | 20.8% to 24.6% |
| lemonade concentrate | 20.8% to 24.6% |
| tequila | no more than 34% |
| orange flavored liqueur | at least 7.6% |
| triple sec | at least 7.6% |
| brandy-based orange liqueur | no more than 5.2%. |

10. The recipe of claim 9 wherein the limeade concentrate and the lemonade concentrate are combined in substantially equal proportions.

11. The recipe of claim 9 wherein the limeade concentrate and the lemonade concentrate are frozen concentrates.

12. The recipe of claim 9 wherein the brandy-based orange flavored liqueur is Grand Marnier.

13. The recipe of claim 9 wherein the orange flavored liqueur is Orangecello.

14. The recipe of claim 9 wherein the pre-made, alcoholic Margarita cocktail mix is a ready-to-drink mixture.

15. The recipe of claim 9 wherein the pre-made, alcoholic Margarita cocktail mix is a frozen slurry mixture.

16. The recipe of claim 9 wherein the ingredients are combined in proportions substantially including:

| | |
|---|---|
| limeade concentrate | 11 to 13 ounces |
| lemonade concentrate | 11 to 13 ounces |
| tequila | no more than 18 ounces |
| orange flavored liqueur | at least 4 ounces |
| triple sec | at least 4 ounces |
| brandy-based orange liqueur | no more than 3 ounces. |

17. The recipe of claim 16 wherein the ingredients are combined to form a batch quantity of the Margarita cocktail mix, in proportions substantially including:

| | |
|---|---|
| limeade concentrate | 12 ounces |
| lemonade concentrate | 12 ounces |
| tequila | 18 ounces |
| orange flavored liqueur | 4 ounces |
| triple sec | 4 ounces |
| brandy-based orange liqueur | 2.75 ounces. |

18. A recipe for a pre-made, alcoholic Margarita cocktail mix, consisting essentially of ingredients combined in proportions substantially including:

| | |
|---|---|
| limeade concentrate | 20.8% to 24.6% |
| lemonade concentrate | 20.8% to 24.6% |
| tequila | no more than 34% |
| orange flavored liqueur | at least 7.6% |
| triple sec | at least 7.6% |
| brandy-based orange liqueur | no more than 5.2%. |

19. The recipe of claim 18 wherein the limeade concentrate and the lemonade concentrate are combined in substantially equal proportions.

20. The recipe of claim 18 wherein the brandy-based orange flavored liqueur is Grand Marnier.

21. The recipe of claim 18 wherein the orange flavored liqueur is Orangecello.

22. The recipe of claim 18 wherein the pre-made, alcoholic Margarita cocktail mix is a ready-to-drink mixture.

23. The recipe of claim 18 wherein the pre-made, alcoholic Margarita cocktail mix is a frozen slurry mixture.

24. The recipe of claim 18 which consists essentially of ingredients combined in proportions substantially including:

| | |
|---|---|
| limeade concentrate | 11 to 13 ounces |
| lemonade concentrate | 11 to 13 ounces |
| tequila | no more than 18 ounces |
| orange flavored liqueur | at least 4 ounces |
| triple sec | at least 4 ounces |
| brandy-based orange liqueur | no more than 3 ounces. |

25. The recipe of claim 24 which consists essentially of ingredients combined to form a batch quantity of the Margarita cocktail mix, in proportions substantially including:

| | |
|---|---|
| limeade concentrate | 12 ounces |
| lemonade concentrate | 12 ounces |
| tequila | 18 ounces |
| orange flavored liqueur | 4 ounces |
| triple sec | 4 ounces |
| brandy-based orange liqueur | 2.75 ounces. |
